(19) United States
(12) Patent Application Publication
(10) Pub. No.: US 2007/0031113 A1
(43) Pub. Date: Feb. 8, 2007

(54) CONTENT MEDIA WITH FORMAT IDENTIFICATION

(76) Inventors: Bradley Thomas Collar, Valencia, CA (US); Lewis S. Ostrover, Los Angeles, CA (US); Wayne M. Smith, La Canada, CA (US)

Correspondence Address: GOTTLIEB RACKMAN & REISMAN PC, 270 MADISON AVENUE, 8TH FLOOR, NEW YORK, NY, 100160601, US

(21) Appl. No.: 11/461,579

(22) Filed: Aug. 1, 2006

Related U.S. Application Data
(60) Provisional application No. 60/706,175, filed on Aug. 5, 2005.

(51) Int. Cl. H04N 7/00

(52) U.S. Cl. 386/95

(57) ABSTRACT

A content media such as a disc is disclosed having a portion with content in one format and a second portion with information in a second format. Typically, the first format may not be compatible with some (usually early) disc players. If a user inserts the disc into an incompatible disc player, the disc player reads the information from the second portion and generates a message to that effect to the user. The message may be a voice message, a text message, an image, etc. In an alternate embodiment, a disc with content in two formats is provided on a disc and the player either plays one of the two formats depending on a default setting, or plays one of the formats in response to a selection by the user

### RELATED APPLICATIONS

This application claims priority to provisional application Ser. No. 60/706,175 filed Aug. 5, 2005 and incorporated herein by reference.

### BACKGROUND OF THE INVENTION

1. Field of the Invention

This invention pertains to content media such as an optical disc having a content portion in a first format, and a format identification portion in a second format. If a user inserts this media into a player that is incompatible with the first format, the format identification portion informs the user that the disc cannot be played. Alternatively, the media may have content in both formats and the player may be compatible with both formats. In this situation, the player allows a user to determine if he wants to play the content in the first format, the second format, or both.

2. Description of the Prior Art

Content is distributed on various types of media. Typical media may include standard single layer DVDs (storing about about 4.7 Gbytes), multilayer DVDs (storing up to 18 Gbytes), as well newer type of optical media such as High Density (HD DVD) discs and blu-ray discs (BD). DVD players have become common in consumer homes. However, these players are incompatible with the newer discs mentioned above. Thus, a disadvantage of these newer types of media is that, even though they look (at least superficially) very similar to CDs and DVDs, there could be consumer confusion since these discs cannot be played by standard DVD players. Therefore, as high capacity HD DVD and/or BD become available and accepted by the industry and the public, there may be frequent instances where an inattentive or unsophisticated user may try to insert one of these media into a standard DVD or CD player. When the player is unable to play the disc, the consumer may get confused and believe that either the player or the disc is defective.

### SUMMARY OF THE INVENTION

The problem described above is overcome by the present invention by providing a disc with data in two different formats. For example, the content on a disc may be in a first format, such as a HD DVD or BD format playable by a first player. However, a relatively small amount of data is provided on the disc (preferably on a preselected or designated area of the disc, such as its lead-in area) that contains machine-readable data including format identification information. Importantly this latter data is in a second format, such as standard DVD or CD, and is playable by a second player. It should be understood that the first player can play discs in both formats while the second player can play discs only in the second format.

In one embodiment, the data includes a message indicating to a user that the content of the disc can be played only on a player compatible with the first format, such as the first player. The message could be in the form of video signals, audio signals, text files, images and so on. The format identification information may also include a code that could be read by the second player to indicate that the format identification data can be skipped.

In another embodiment, a disc with content in said first and second format is provided with a format identification zone. When the disc is inserted into a player capable of playing both formats, the user is given the choice of playing the content in the first format, second format, or both.

### BRIEF DESCRIPTION OF THE DRAWINGS

FIG. 1 shows a plan view of a disc having format identification information in accordance with this invention;

FIG. 2A shows a somewhat diagrammatic sectional view of the disc of FIG. 1;

FIG. 2B shows a block diagram of a system with a standard DVD player coupled to a TV set and receiving the disc of FIGS. 1 and 2A;

FIG. 3 shows a flow chart illustrating the operation of standard DVD player receiving the disc of FIGS. 1 and 2;

FIG. 4 shows a flow chart illustrating a first mode of operation of an HD DVD player receiving the disc of FIGS. 1 and 2;

FIG. 5 shows DVD data including a message and a special code;

FIG. 6 shows a flow chart illustrating a second mode of operation of the high capacity player receiving the disc of FIGS. 1 and 2;

FIG. 7 shows a flow chart illustrating a third mode of operation of the high capacity player receiving the disc of FIGS. 1 and 2;

FIG. 8 shows a somewhat diagrammatic sectional view of DVD disc with format identification information in a CD format;

FIG. 9 shows a somewhat diagrammatic sectional view of BD DVD disc with format identification information;

FIG. 10 shows a block diagram of a system with a player coupled to a TV set and being adapted to play discs in different formats; and

FIG. 11 shows a side elevational view of a dual layered data disc.

### DETAILED DESCRIPTION OF THE INVENTION

The present application pertains to media such as a disc having content in a first format that is compatible with a first player but is incompatible with a second player. For example, the first player may be configured to play discs in a new format that has not gained broad general acceptance while the second player may be configured to play discs in a very popular format but is not forward compatible with the new format. The first player may, and usually can play discs in both formats. In the following description, the first format is referred to as a high capacity or HD DVD format and the second format is the referred to as a low capacity or DVD format strictly for illustrative purposes.

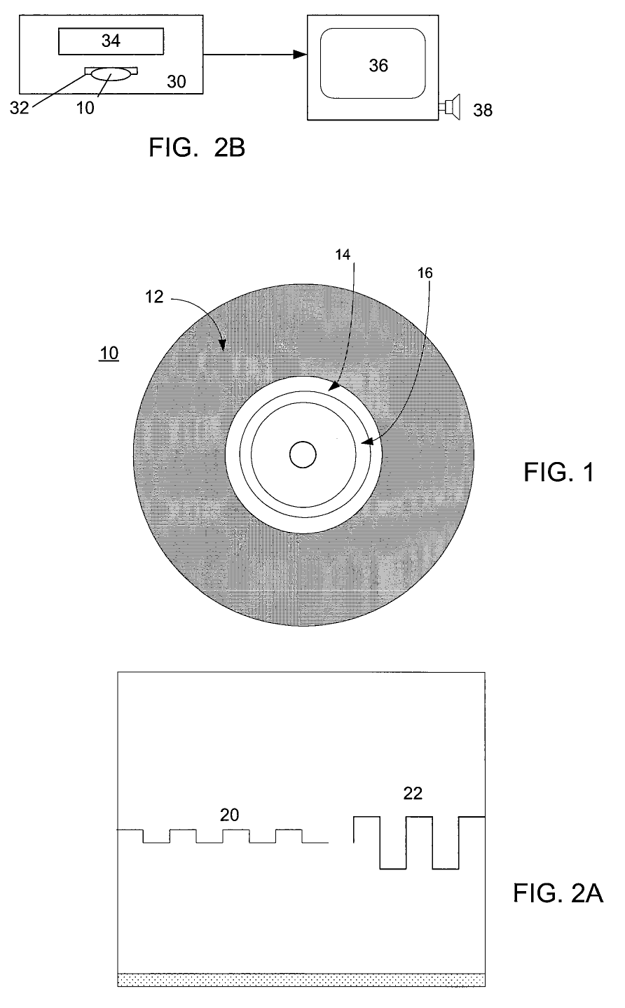

FIG. 1 shows a disc 10 having a main data area or portion 12 used to record content and other associated information and a lead-in area or portion 14. The lead-in area 14 is used for data that provides information to a player about the data in area 12, such as a table of contents. The lead-in area 14 has data in the same format as the content in area 12, e.g., HD DVD.

As discussed above, a problem with high capacity discs, such as an HD DVD is that they are not backward compatible with standard DVD players. Therefore, if a user inserts an HD DVD disc by mistake into a standard DVD player, the player is unable to play it, thereby annoying and confusing the user. This problem is eliminated in the present invention by providing a format identification area or portion 16. Preferably, this format identification area 16 is disposed radially inward of lead-in area 14 or within the lead-in area, although it may be located at other locations on the disc 10 as well. Data in this area 16 is recorded in a low capacity format that is compatible with current players (including stand-alone players and software players incorporated in a PC). In the present example, area 16 contains data in a standard DVD format.

Thus, as illustrated in FIG. 2A, data is recorded on the disc 10 in two formats: content in area 12 and lead-in data in area 14 are recorded in a high capacity format such as a HD DVD format, shown somewhat diagrammatically at 20, and format identification information is recorded in a low capacity format, such as a standard DVD format, shown in FIG. 2A at 22. The format identification may be provided using various types of signals. For example, this information may be stored as a message in the form of text, audio signals, video signals, and so on, discussed in more detail below.

FIG. 2B shows a standard playback system receiving a disc 10 constructed in accordance with this invention. As shown in the Figure, a standard standalone DVD player 30 is provided with a slot 32 for receiving DVD discs and an optional screen 34 displaying information about the discs received, and/or messages related to the operation of the player 30. The player 30 is connected to a standard TV set 36. As discussed above, player 30 may also be a PC with software adapted to play DVDs.

After disc 10 is inserted into the player 30, the player looks first for data in a data lead-in area. As discussed above, preferably, the format identification area is disposed inwardly of the lead-in area 14 and therefore the player 30 finds data in this area first. As described above, the data includes or consists of a message, and instructions to the player to present this message to the user. For example, the message may be a video message such as “THIS IS A HIGH DEFINITION DISC THAT CANNOT BE USED IN THIS PLAYER. IF YOU WANT TO SEE THE CONTENTS OF THIS DISC, PLEASE INSERT IT INTO AN HD DVD PLAYER.” This video message requires only a few bytes of data and can be recorded in area 16. Alternatively, if area 16 is part of the lead-in area and is too small to contain the whole message, then another area on the disc is designated for this message, and area 16 contains a pointer to this other area.

In another embodiment of the invention, the data could include an audio message with similar message content. The audio message is played on the speaker 38 of TV set 36. Alternatively, or in addition, the data may include a text message. The text message can be shown on screen 34.

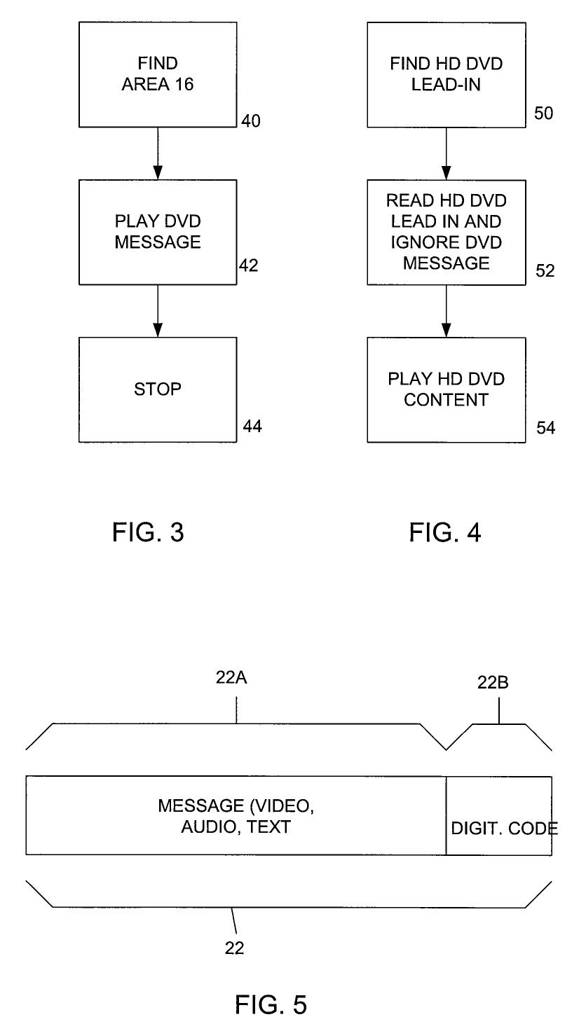

FIG. 3 shows the operation of the player 30. In step 40 the disc 10 is inserted into the player 30 and the player then looks for, and finds the format identification area 16 in DVD format. In step 42 the player 30 plays the message as discussed above, to indicate to the user that the DVD 10 is incompatible with the player 30. The player 30 then stops in step 44. In this manner, if a user inserts disc 10 into an incompatible player, he is alerted to the fact that the disc 10 is incompatible with player 30.

Most high capacity disc players are provided with circuitry which enables them to read various types of discs, including CDs, standard DVDs, and high capacity (e.g. HD DVD and/or BD) discs. Each player may be set so that when any disc is inserted, a search is conducted for data in various formats in a predetermined order. For example, the search may start with data in the highest capacity format first, followed by the next highest and so on. Once data is found in a format, it is assumed that no other data exists on the disc and only the data in the format found is played. If disc 10 is introduced in this type of player, then the player operates as shown in FIG. 4. In step 50 player looks for, and finds the lead-in area 14. In step 52 the player reads the data in the lead-in area 14 and ignores the DVD message in area 16. In step 54 the player plays the content in accordance with the lead-in area 14. Thus, the player reads only the high capacity format information on the disc 10. However, the players may also be set to search for data in a different order. For example, the players may be set to look for data in the most common or popular format, or data in the lowest capacity format. In these cases, if the player receives disc 10, it finds area 16 first, plays the DVD message, and stops, even though it can play the rest of the disc as well. In order to prevent this type of operation, the disc 10 is modified by incorporating into area 16 a special code or other signal that alerts the player that the disc also has data in a high capacity format that has to be played as well. This concept is illustrated in FIG. 5, wherein the DVD message is designated by numeral 22A and the special code is designated by numeral 22B.

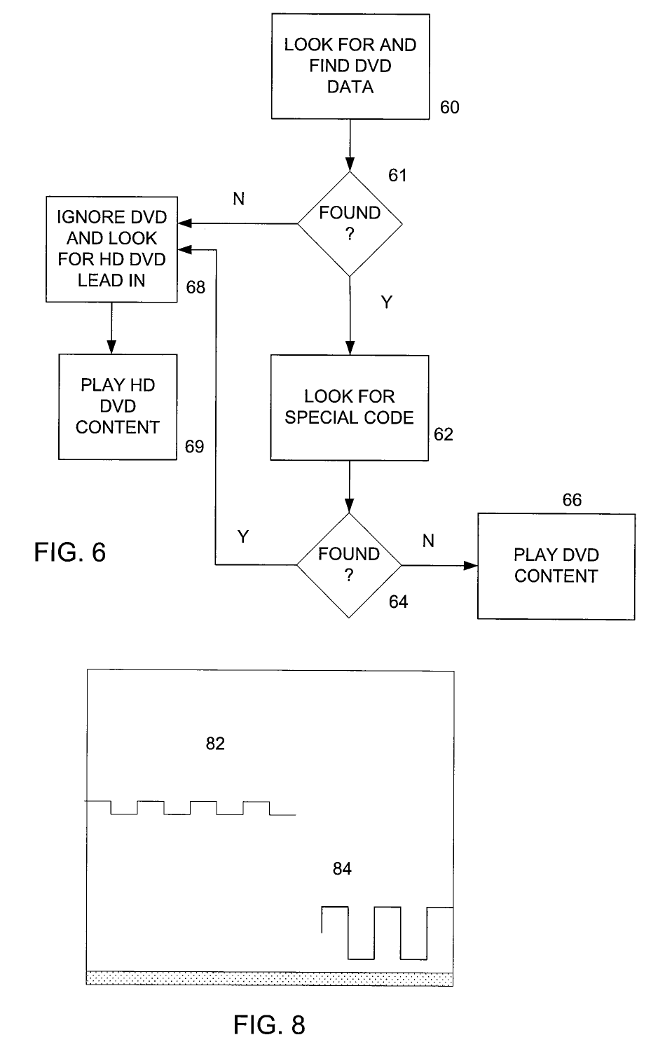

The circuitry of the player is also changed so that it operates as illustrated in FIG. 6. The disc with a modified area 16 is inserted into the player, and in step 60 the player looks for data in DVD format (22A and 22B) in area 16. If data in this format is found in step 61, then, in step 62 the player looks for the special code 22B indicating that the disc does not contain actual content data in DVD format. (Alternatively, the player can look for the DVD message and interpret the message as being the special signal).

If the special code 22B is not found in step 64 then the player assumes that the disc is a standard DVD disc and in step 66 its content is played in the usual manner. If the special code is found in step 64 then in step 68 the player ignores the DVD data and, instead, looks for the lead-in are 14 in a high capacity format, and then plays the high capacity format content in step 69 in the usual manner.

Going back to step 61, if the player does not find any data in DVD format then the content of the disc in the high capacity format is played in steps 68 and 69 in the usual manner.

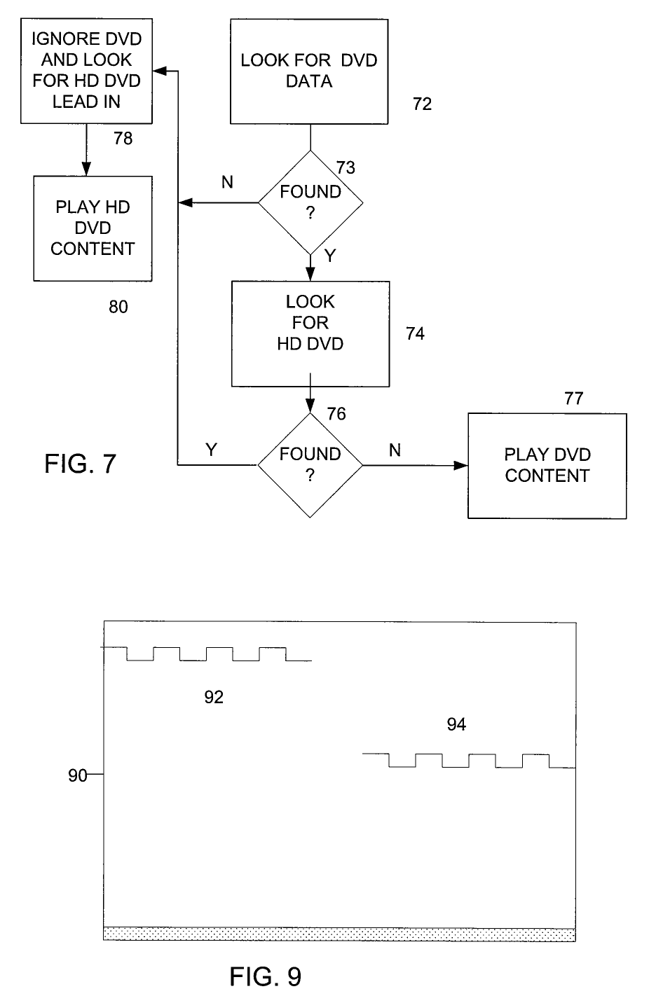

FIG. 7 shows an alternate embodiment of the invention. In step 72, a high capacity player receives disc 10 and is looking for DVD format data. If in step 73 the DVD format data is found then in step 74 the player looks for high capacity format data. If such data is found in step 76, then the player assumes that it should play only the high capacity data. Therefore, in step 78 the player ignores the DVD format data but instead reads the high capacity lead-in data and in step 80 it plays the high capacity content in the usual manner.

If no high capacity format data is found in step 76 then the player plays the standard DVD content in step 77.

Similarly, if no DVD data is found in step 73 then the high capacity format data is read and played in steps 78 and 80, respectively. This embodiment does not require a special code 22B.

As discussed above, in one embodiment disc 10 is a high capacity DVD disc that has a message warning in standard DVD format to indicate that the disc is not compatible with standard DVD players. Of course, this concept can be extended to other formats as well. For example, a disc may be made that has a similar structure to disc 10 of FIG. 1, however, the warning message is provided on the disc to indicate that the disc is not compatible with a standard CD player. For this purpose, a disc is made with content in HD DVD format, an HD DVD format lead-in 82 and a message 84 in CD format 82, as shown in FIG. 8. The players for playing these discs operate in the manner discussed above.

Moreover, the same principles may also be used for other types of high capacity DVD discs, such as BD. Such a disc 90 is shown in FIG. 9 with data 92 including content and lead-in BD format and a message 91 being provided in standard DVD format as shown.

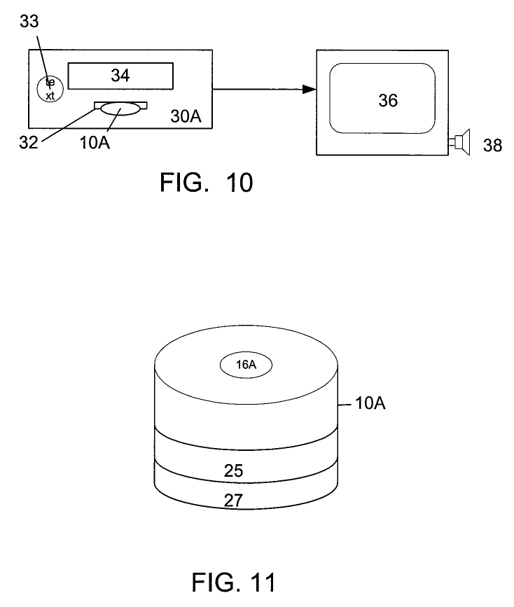

Another embodiment of the invention is shown in FIGS. 10 and 11, a player 30A plays discs of both formats and is provided with a slot 32, a display 34 for displaying commands and a control button 33. The player sends content to monitor 36 and speaker 38. Player 30A receives disc 10, it performs in one of the modes of operation described above.

FIG. 11 shows a dual disc 10A that has two data layers, one data layer 25 having content in a first format, and a lead-in area (not shown) with disc identifying information indicating that this is a dual disc, i.e., a disc with two content layers in two different formats. The second layer 27 includes content in a second format and optionally its own lead-in area (not shown).

When player 30A receives disc 10A through its slot 32, it first the lead-in area (or any other area or zone provided on the disc for this purpose) for the disc identifying information. When a dual disc is indicated by this information, the player provides a message to that effect on the display 34 and gives a choice to the user to select each layer 25, layer 27 or both, preferably in sequence. The user selects his choice using selector 33 and the player then operates accordingly. This player can operate in several modes. In one mode, the player receiving a disc first reads the content in a default mode (which may be preselected as a popular mode, a low capacity mode, etc.) Alternatively, for example, in response to a preselected option, when a disc with dual content is detected, the player provides an option to a user to select the first format, the second format or both and then plays the content in the selected format(s).

In the specific examples given above, a disc with data in two different portions having data in different formats is disclosed with the two formats having different physical characteristics. Of course, it should be understood that the two portions may differ in other ways as well. For example, the two formats may be different logic formats, different application and/or different physical formats.

The invention has been described as it is implemented on an optical disc. However, one skilled in the art will understand that it is equally applicable to other media as well.

Numerous modifications may be made to this invention without departing from its scope as defined in the appended claims.

We claim:

1. A digital data media comprising:
a first portion having content in a first format and a second portion with information in a second format, said information including an indication of the format of said content to a user.

2. The media of claim 1 wherein said formats have different physical, logical or application-related characteristics.

3. The media of claim 1 wherein said first format has a higher data capacity than said second format.

4. The media of claim 1 further comprising an optical disc with different data layers, said first portion being disposed in one data layer and said second portion being disposed in a second data layer.

5. The media of claim 1 further comprising an optical disc selected from a high capacity DVD and a DVD.

6. The media of claim 5 wherein said first format is selected from an HD-DVD, BD, and standard DVD formats.

7. The media of claim 6 wherein said second format is selected from a standard DVD and a CD format.

8. A computer-readable media comprising a first portion with content in a first format and a second portion with information in a second format, said information including indicia for a user of said first format.

9. The media of claim 8 further comprising a lead-in area, with said second portion being disposed in said lead-in area.

10. The media of claim 8 further comprising a lead-in area with said second portion being disposed adjacent to said lead-in area.

11. The media of claim 8 wherein said first portion is disposed at a first data level within the disc and said second portion is disposed at a second data level within the disc.

12. The media of claim 8 wherein said first portion is disposed at one of a DVD level, a HD DVD level and a BD level.

13. The media of claim 12 wherein said second portion is disposed at one of a DVD level and a CD level.

14. The media of claim 8 wherein said second portion further includes a code selected to indicate to a disc player to ignore said information.

15. A method of playing an optical disc having a first portion with content in a first format and information in a portion having a second format, said information including an indication related to said first format, said optical disc being read by a disc player that is compatible with said first format, comprising:
determining if said disc includes said first and said second portions; and
playing said first portion.

16. The method of claim 15 wherein said disc includes a specific code in said second portion, further comprising operating said player to read only said first portion and ignoring said second portion.

17. A method of generating an indication for a user trying to play an optical disc having a first portion with content in a first format and information in a portion having a second format, said information including an indication related to said first format, using disc player that is incompatible with said first format, comprising:
reading said information from said second portion;
generating a message to the user based on said indication to alert the user that the disc is incompatible with said disc player.

18. The method of claim 17 wherein said message is an oral message.

19. The method of claim 17 wherein said message is an image.

20. The method of claim 17 wherein said message includes text.

21. A method of playing a disc having a first content in a first format and a second content in a second format comprising:
inserting said disc in a disc player;
identifying said disc by said disc player as having contents in said first and second formats;
displaying a message to a user indicating that contents are available in said first and second formats;
receiving a command from a user; and
playing at least one of said first and second contents in response to said command.
